(19) United States
(12) Patent Application Publication
(10) Pub. No.: US 2012/0058237 A1
(43) Pub. Date: Mar. 8, 2012

(54) FOOD PROCESSING FOR AGRICULTURAL BIODIVERSITY

(76) Inventor: Daniel Bruce VanWart, Dedham, ME (US)

(21) Appl. No.: 12/877,042

(22) Filed: Sep. 7, 2010

(51) Int. Cl. A23L 1/0522; A23L 1/05

(52) U.S. Cl. 426/550; 426/629

(57) ABSTRACT

A formed food product including wild blueberry seeds and a method for producing such food product without damaging the wild blueberry germplasm such that seed viability is enhanced. The method contributes to the conservation and sustainable utilization of agricultural biodiversity. The formed food product is interspersed with seeds processed by way of the method to enable natural seed distribution in an edible manufactured food product. The formed food product, even after reaching its expiration date, provides seeds within it that are still be viable and can be extracted for future use.

### FIELD OF THE INVENTION

The present invention relates generally to the preservation of germplasm in food processing for human and animal consumption. More particularly, the present invention relates to processing of wild blueberries into a food item that maintains the viability of blueberry seeds.

### BACKGROUND OF THE INVENTION

Agricultural biodiversity encompasses the variety and variability of animals, plants and microorganisms which are necessary to sustain key functions of the agroecosystem, its structure and processes for, and in support of, food production and food security. Since the dawn of agriculture 12,000 years ago, humans have nurtured plants and animals to provide food. Careful selection of the traits, tastes and textures that make good food resulted in a myriad diversity of genetic resources, varieties, breeds and sub-species of the relatively few plants and animals humans use for food and agriculture. Agricultural biodiversity also includes the diversity of species that support production—soil biota, pollinators, predators and so on—and those species in the wider environment that support diverse agroecosystems—agricultural, pastoral, forest and aquatic ecosystems.

These diverse varieties, breeds and systems underpin food security and provide insurance against future threats, adversity and ecological changes. Agricultural biodiversity is the first link in the food chain, developed and safeguarded by indigenous peoples, and women and men farmers, forest dwellers, livestock keepers and fisherfolk throughout the world. It has developed as result of the free-flow of genetic resources between food producers. The collection of genetic resources for an organism is termed “germplasm” and underpins agricultural biodiversity.

This agricultural biodiversity is under threat. Animal breeds, plant varieties and the genetic resources they contain are being eroded at an alarming rate. More than 90% of crop varieties have been lost from farmers' fields in the past century and livestock breeds are disappearing at the rate of 5% per year and aquatic life is similarly threatened. Soil biodiversity including microbial diversity and the diversity of pollinators and predators are also under serious threat. Urgent actions are needed to reverse these trends in situ and on-farm. Also, there is a need to implement actions to protect the genetic resources stored in ex situ public genebanks, which are often poorly maintained. Threats to these resources, both in situ and ex situ, also include pollution by genetically modified material. This loss of diversity is accelerating the slide down the slippery slope of food insecurity that today sends more than 1.2 billion people to bed, hungry.

One way forward is to develop sustainable agroecological production systems that enhance diversity by protecting germplasm in food processing.

### SUMMARY OF THE INVENTION

It is an object of the present invention to obviate or mitigate at least one disadvantage of previous agroecological production systems. In general, the present invention contributes to keeping the germplasm of crops and their “wild” relatives in the public domain. Moreover, the present invention maintains the integrity of a crop processed into a food product in such a way so that the food product can easily and readily be reduced to the natural and living plant that produced it.

In a first aspect, the present invention provides a method including: subjecting fruit berries to a reduced temperature sufficient to produce seed stratification; thawing the fruit berries to a temperature sufficient to release natural juices of the fruit berries; blending the fruit berries to produce a puree; thickening the puree with a dehydrated natural thickening ingredient to produce a dough; forming molded shapes from the dough; and drying the molded shapes; wherein seeds of the fruit berries retain their viability to regenerate one or more plants from which the fruit berry was borne.

In a further embodiment, there is provided a formed food product, the product including: a plurality of fruit berry seeds dispersed within a biscuit, the biscuit formed by the steps including: subjecting fruit berries including the fruit berry seeds to a reduced temperature sufficient to produce seed stratification; thawing the fruit berries to a temperature sufficient to release natural juices of the fruit berries; blending the fruit berries to produce a puree; thickening the puree with a dehydrated natural thickening ingredient to produce a dough; forming molded shapes from the dough; and drying the molded shapes to produce the biscuit; wherein the fruit berry seeds retain their viability to regenerate one or more plants from which the fruit berry was borne.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures.

FIG. 1 shows a flow diagram of the steps in accordance with the method of the present invention.

FIG. 2 shows a food product produced by the steps in accordance with the method shown in FIG. 1.

### DETAILED DESCRIPTION

Generally, the present invention provides a food product including wild blueberry seeds and a method for producing such food product without damaging the wild blueberry germplasm such that seed viability is enhanced. Moreover, the present inventive method contributes to the conservation and sustainable utilization of agricultural biodiversity. Advantageously, even after the food product of the present invention has reached its expiration date the seeds within it would still be viable and could be extracted for future use.

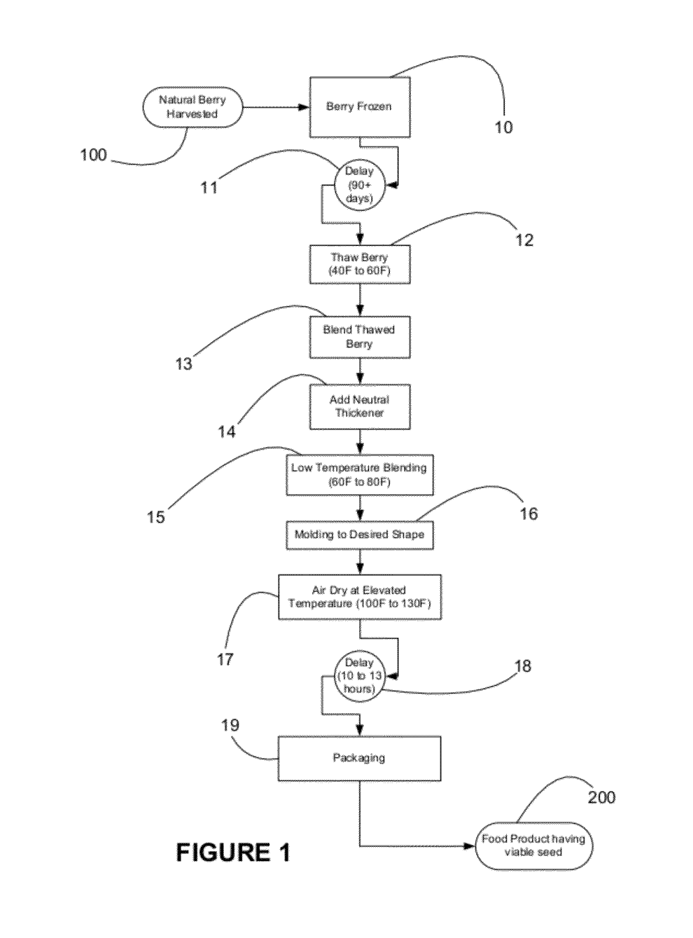

With reference to FIG. 1, a flow chart is shown that illustrates the steps included in regard to the present invention. Here, a natural wild blueberry is provided at 100 by any known method of harvesting well understood within the agricultural arts. Once harvested and brought into a processing facility, the berry is immediately frozen at step 10. A suitable temperature range for freezing the berry is between 0° F. and −10° F.

Step 10 is followed by a delay 11 which protracts the freezing of the berry for at least ninety (90) days. This freezing process reduces the presence of unwanted pathogens as it is well understood that frozen foods do not require many preservatives because the process of preparing the food for freezing kills much of the bacteria living on the food. The freezing step enables stratification to occur within the blueberry seeds which breaks the seeds' nest period. Like many seeds, wild blueberry seeds will not sprout until the dormancy phase is broken. The time it takes to stratify depends on species—although in most cases ninety (90) days is sufficient.

Once the wild blueberries have been frozen for at least ninety (90) days, they are then allowed at step 12 to thaw to a temperature of between 40° F. and 60° F. Thawing allows for the natural juices and sugars to be freely released from the cells of the berry. Once thawed, the berries are blended at step 13 to provide a puree that evenly distributes the natural juices, sugars, and berry seeds.

The puree is thickened at step 14 by the addition of a neutral ingredient. Such neutral ingredient may be selected from apple powder, potato flour, or any suitable dehydrated natural fruit or vegetable powder. It is important to note that the neutral thickening ingredient is also a food grade product that is free from pathogens. Only the berry puree and the neutral ingredient are blended and no water is added. It should be well understood that the particular proportion of the neutral thickening ingredient relative to the berry puree is dependent upon the amount of natural moisture content in the given berry harvest and also the particular thickening powder selected. Accordingly, varied proportions are well within the intended scope of the present invention so long as a suitable dough formation is enabled during the blending step 15.

Once a dough consistency suitable for forming the mixture into shapes is obtained by way of the blending step 15, the blended material is then molded into any desired shape at step 16. It should be readily understood that the specific molded shape is subject to the given requirements of the resulting food product. For example, if the resulting food product created by the inventive method was a dog biscuit, then a classic dog bone shape may be desirable. However, if meant for human consumption, the resulting food product may be shaped to resemble the leaf of a blueberry plant. Any shape is therefore well within the intended scope of the present invention.

It terms of implementation, it should be understood that molding step 16 may be accomplished by any known food making machine such as a rotary molder device. Such devices typically include a drum that has the desired shape cut into it and a hopper that contains the prepared dough. The drum rotates into position and a series of paddles in the hopper press the dough into the cut-out shape in the drum. The drum rotates down and a small plunger pushes the dough from behind to the surface of the drum whereby the shaped dough comes into contact with a wire drum scraper. By way of the scraper, the formed food product is then smoothly ejected onto a conveyor, presenting it for additional processing drying as per step 17.

The drying step 17 provides that the shaped dough forms are air dried. Elevated temperatures of between 100° F. and 130° F. are provided through the use heated air for a duration (shown by delay 18) of ten (10) to thirteen (13) hours in order to harden the shaped dough forms to a sufficient dryness suitable to enable packaging at step 19. The resulting food product obtained by way of the inventive method is a food product 200 having viable seeds interspersed throughout the food product.

It should be readily understood that the present method freezes the berries immediately after harvesting which not only breaks the nesting period, but also kills pathogens. The ingredients added to the berries, once thawed and pureed, are dehydrated powders which are free of pathogens. Without the addition of water, the dough is formed by way of the natural juices of the berries which are rich in sugar along with the powdered thickener to create the dough. The mixture is then formed into shapes and immediately dehydrated as a means of preservation. The water activity level of the resulting food product, once dehydrated by air drying, are low enough to preclude microbial growth.

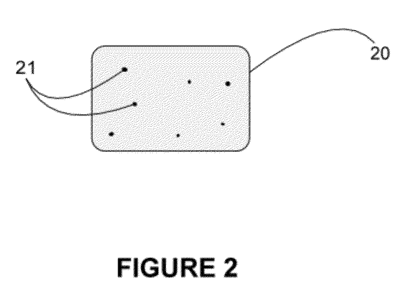

FIG. 2 shows a simplified example of a formed food item 20 after having been slowly air dried and ready for packaging. The formed food item 20 includes wild blueberry seeds 21 interspersed throughout. It should be understood that while many seeds may be visible from the surface of the formed food item 20 many others are embedded within the inner portion of the formed food item 20.

The formed food item 20 thus produced by way of the inventive method is packaged and offered for retail sale completely free of preservatives and capable of regenerating the plant from which its main ingredient came. This is enabled by the inventive method not exceeding the temperatures or pressures that the seed would naturally be exposed to if left in nature. This method is a vast improvement over the known food processing methods for animal biscuits which are processed through high pressure, high temperature extrusion equipment and then either baked or dehydrated at high temperatures in the name of speed and efficiency. Such existing processing completely kills the seed and any chance of regeneration.

In practice, the seeds processed by the method of the present invention will of course be eaten by the consumer (human or animal) and subjected to normal digestive events within the gut of the consumer. Once expelled from the digestive system of the consumer, the seed is capable of regeneration. In consumption, for example, by dogs whereby the formed food product is a dog biscuit including wild blueberry seeds, it should therefore be readily apparent that the dog may enable the spread of wild blueberry plants through the depositing of excreted waste products upon the earth. Likewise, the present invention has useful and novel application to formed food products for human consumption in the market of hiking and camping snack items. In such market, a human camping in the woods would likewise distribute viable seeds through their excreted waste products. Notwithstanding such animal and human consumption, the present invention also has applications in the science demonstration project market such that the formed food product can be both eaten and directly planted to illustrate agricultural food cycles. Still further, the formed food product has a useful life beyond its fitness for human or animal consumption. That is to say, once the formed food product has outlived its approved shelf life, the seeds embedded therein are still viable for spreading biodiversity through their direct planting in the earth. It should be understood that while wild blueberries and their seeds have been the focus of the above description, the present inventive method is useful for the production of other fruit and berry based food items, treats, and snacks without straying from the intended scope of the present invention.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
subjecting fruit berries to a reduced temperature sufficient to produce seed stratification;
thawing said fruit berries to a temperature sufficient to release natural juices of said fruit berries;
blending said fruit berries to produce a puree;
thickening said puree with a dehydrated natural thickening ingredient to produce a dough;
forming molded shapes from said dough; and
drying said molded shapes;
wherein seeds of said fruit berries retain their viability to regenerate one or more plants from which said fruit berry was borne.

2. The method as claimed in claim 1, wherein said step of subjecting said fruit berries to a reduced temperature in maintained for at least ninety days.

3. The method as claimed in claim 2, wherein said step of subjecting said fruit berries to a reduced temperature includes freezing said fruit berries at between −10° F. and 0° F.

4. The method as claimed in claim 1, wherein said temperature sufficient to release natural juices during said thawing step is a range between 40° F. and 60° F.

5. The method as claimed in claim 1, wherein said dehydrated natural thickening ingredient in said thickening step is apple powder.

6. The method as claimed in claim 1, wherein said dehydrated natural thickening ingredient in said thickening step is potato flour.

7. The method as claimed in claim 1, wherein said thickening step occurs whereby said puree and said dehydrated natural thickening ingredient are maintained at a temperature of between 60° F. and 80° F.

8. The method as claimed in claim 1, wherein said thickening step occurs whereby said puree and said dehydrated natural thickening ingredient are maintained at a temperature of between 60° F. and 80° F.

9. The method as claimed in claim 1, wherein said drying step occurs whereby said molded shapes are maintained at an elevated temperature of between 100° F. and 130° F.

10. The method as claimed in claim 9, wherein said elevated temperature is maintained for between ten and 13 hours.

11. A formed food product, said product comprising:
a plurality of fruit berry seeds dispersed within a biscuit, said biscuit formed by the steps including:
subjecting fruit berries including said fruit berry seeds to a reduced temperature sufficient to produce seed stratification;
thawing said fruit berries to a temperature sufficient to release natural juices of said fruit berries;
blending said fruit berries to produce a puree;
thickening said puree with a dehydrated natural thickening ingredient to produce a dough;
forming molded shapes from said dough; and
drying said molded shapes to produce said biscuit;
wherein said fruit berry seeds retain their viability to regenerate one or more plants from which said fruit berry was borne.

12. The formed food product as claimed in claim 11, wherein said step of subjecting said fruit berries to a reduced temperature in maintained for at least ninety days.

13. The formed food product as claimed in claim 12, wherein said step of subjecting said fruit berries to a reduced temperature includes freezing said fruit berries at between −10° F. and 0° F.

14. The formed food product as claimed in claim 11, wherein said temperature sufficient to release natural juices during said thawing step is a range between 40° F. and 60° F.

15. The formed food product as claimed in claim 11, wherein said dehydrated natural thickening ingredient in said thickening step is apple powder.

16. The formed food product as claimed in claim 11, wherein said dehydrated natural thickening ingredient in said thickening step is potato flour.

17. The formed food product as claimed in claim 11, wherein said thickening step occurs whereby said puree and said dehydrated natural thickening ingredient are maintained at a temperature of between 60° F. and 80° F.

18. The formed food product as claimed in claim 11, wherein said thickening step occurs whereby said puree and said dehydrated natural thickening ingredient are maintained at a temperature of between 60° F. and 80° F.

19. The formed food product as claimed in claim 11, wherein said drying step occurs whereby said molded shapes are maintained at an elevated temperature of between 100° F. and 130° F.

20. The formed food product as claimed in claim 19, wherein said elevated temperature is maintained for between ten and 13 hours.
